(19) United States
(12) Patent Application Publication
(10) Pub. No.: US 2002/0110187 A1
(43) Pub. Date: Aug. 15, 2002

(54) Method and apparatus for providing domain conversions for multiple channels and applications thereof

(75) Inventor: Michael R. May, Austin, TX (US)

Correspondence Address: TIM MARKSION, GENERAL COUNSEL, SIGMATEL, INC, 2700 VIA FORTUNA, SUITE 500, AUSTIN, TX, 78746, US

(73) Assignee: SigmaTel, Inc.

(21) Appl. No.: 09/782,531

(22) Filed: Feb. 13, 2001

(51) Int. Cl. H04B 1/38; H04L 5/16

(52) U.S. Cl. 375/222

(57) ABSTRACT

A method and apparatus for domain conversions for multiple channels within a single analog front-end include processing that begins by generating a system clock. The processing continues by converting a frequency of 1^{st} data from a 1^{st} channel frequency to a 2^{nd} channel frequency based on a 1^{st} integer ratio of the system clock. The processing continues by converting the domain of the 1^{st} data rate from a 1^{st} domain to a 2^{nd} domain. The processing continues by converting a frequency of the 2^{nd} data of a 2^{nd} channel from a 2 channel frequency to the 2^{nd} frequency based on a 2^{nd} integer ratio of the system clock. For example, the rate of the 2^{nd} data may be different than the rate of the 1^{st} but both are converted to the 2^{nd} frequency, which is universally used within the analog front-end. The proceeding continues by converting the domain of the 2^{nd} data from the 1^{st} domain to the 2^{nd} domain.

### RELATED PATENT APPLICATIONS

METHOD AND APPARATUS FOR PROVIDING DATA FOR SAMPLE RATE CONVERSION having an attorney docket number of SIG000063 and a filing the date the same as the present patent application; and

METHOD AND APPARATUS FOR ADJUSTING TIMING IN A DIGITAL SYSTEM having an attorney docket number of SIG000060 and a filing the date the same as the present patent application.

### TECHNICAL FIELD OF THE INVENTION

This invention relates generally to telecommunications and more particularly to an analog front-end for use in such telecommunication systems.

### BACKGROUND OF THE INVENTION

As is known, data may be communicated from one entity (e.g. end users, computers, server, facsimile machine et cetera) to another entity via a communication infrastructure. The communication infrastructure may include a public switch telephone network (PSTN), the Internet, wireless communication system, and/or a combination thereof. Such a communication infrastructure supports many data communication protocols, which prescribe the formatting of data for accurate transmission from one entity to another. Such data communication protocols include digital subscriber line (DSL), asymmetrical digital subscriber line (ADSL), universal asymmetrical digital subscriber line (UADSL or G.Lite), high-speed digital subscriber line (HDSL), symmetrical high-speed digital subscriber lines (HDSL), asynchronous transfer mode (ATM), Internet protocol (IP), et cetera.

Each of the various data transmission protocols prescribes the formatting of data into frames. Each frame may include a header section, which identifies information particular to the frame, and a data section, which carries the communication data. The data section may be divided into a plurality of data segments, time slots, carrier-frequency bins, packets, et cetera. Depending on the particular data transmission protocol, a frame of data will be transmitted in a continuous manner or in a discontinuous manner. For example, IP and ATM data transmission protocols packetize a frame of data and the packets are transmitted in a discontinuous manner. In contrast, xDSL data transmission protocols require the frames to be transmitted in a continuous manner.

For xDSL data transmission protocols, the data is processed within a modem of a given entity in the digital domain and converted to the analog domain for transmission via the communication infrastructure. Conversely, data is received via the communication infrastructure in the analog domain and converted into the digital domain for further processing. For xDSL modems, the analog to digital conversion and digital to analog conversion are done in an analog front-end. As the need for further integration and functionality of modems increases, the need for more complex analog front-ends increases accordingly.

Therefore, a need exists for a method and apparatus that provides domain conversion for multiple channels, e.g. telecommunication paths.

### BRIEF DESCRIPTION OF THE DRAWINGS

FIG. 1 illustrates a schematic block diagram of a multi-channel analog front-end in accordance with the present invention;

FIG. 2 illustrates an alternate multi-channel front-end in accordance with the present invention;

FIG. 3 illustrates a schematic block diagram of another alternate multi-channel analog front-end in accordance with the present invention;

FIG. 4 illustrates a schematic block diagram of yet another multi-channel analog front-end in accordance with the present invention;

FIG. 5 illustrates a schematic block diagram of an apparatus for providing domain conversions for multiple channels in accordance with the present invention; and

FIG. 6 illustrates a logic diagram of a method for providing domain conversions for multiple channels in accordance with the present invention.

### DETAILED DESCRIPTION OF A PREFERRED EMBODIMENT

Generally, the present invention provides a method and apparatus for domain conversions for multiple channels within a single analog front-end. The method and apparatus include processing that begins by generating a system clock. The processing continues by converting a frequency of 1^{st} data from a 1^{st} channel frequency to a 2^{nd} frequency based on a 1^{st} integer ratio of the system clock. For example, the data rate of the data in a 1^{st} channel is converted to a system level rate. The processing continues by converting the domain of the 1^{st} data rate from a 1^{st} domain to a 2^{nd} domain. For example, the domain is converted from the analog domain to the digital domain or the digital domain to the analog domain. The processing continues by converting a frequency of the 2^{nd} data of a 2^{nd} channel from a 2^{nd} channel frequency to the 2^{nd} frequency based on a 2^{nd} integer ratio of the system clock. For example, the rate of the 2^{nd} data may be different than the rate of the 1^{st} but both are converted to the 2^{nd} frequency, which is universally used within the analog front-end. The processing continues by converting the domain of the 2^{nd} data from the 1^{st} domain to the 2^{nd} domain. With such a method and apparatus, a multiple channel analog front-end is achieved in an integrated format that provides for increased integration of telecommunication services and a corresponding decrease in cost per telecommunication services.

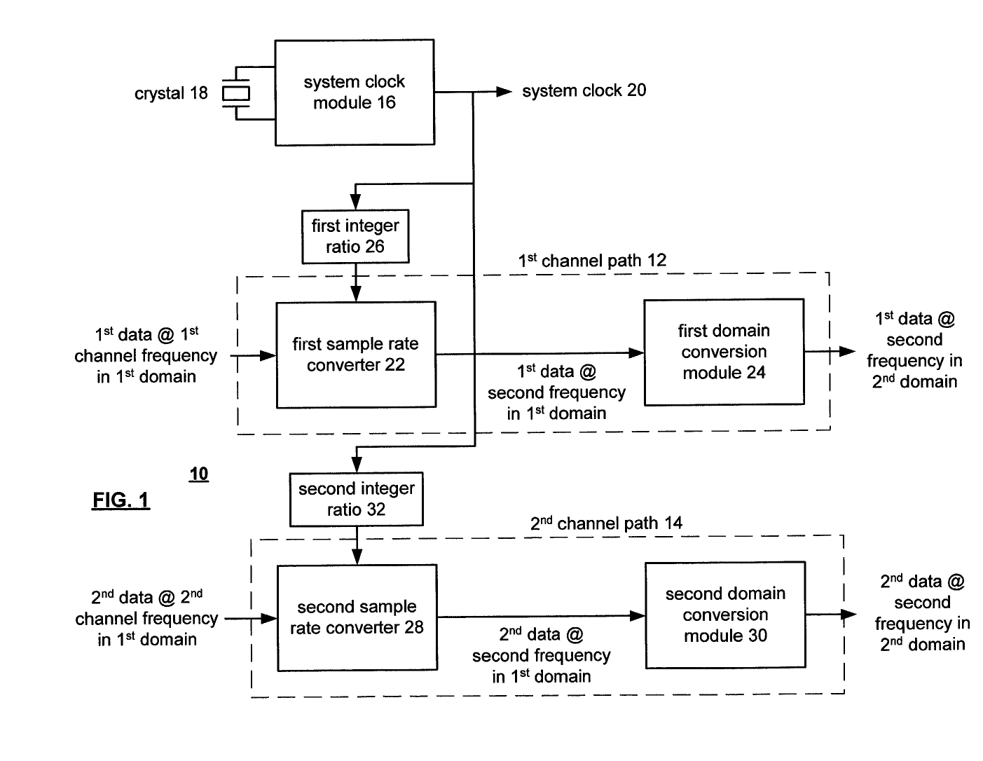

The present invention can be more fully described with reference to FIGS. 1 through 6. FIG. 1 illustrates a schematic block diagram of a multi-channel analog front-end 10 that includes a 1^{st} channel path 12, a 2^{nd} channel path 14 and a system clock module 16. The system clock module 16 is operably coupled to a crystal 18 and produces a system clock 20 that has a given frequency, for example 35 MHz. Depending on the desired frequency, the system clock module 16 may include a simple pair of inverters, a pair of inverters and a phase lock loop, and/or any known mechanism for generating a reliable clock signal from a crystal. Note that the crystal 18 may be eliminated if the system clock 20 is available in the final application from another clock source.

The 1^{st} channel path 12 includes a 1^{st} sample rate converter 22 and a 1^{st} domain conversion module 24. The 1^{st} sample rate converter 22 receives the 1^{st} data at a 1^{st} channel frequency in a 1^{st} domain. Based on a 1^{st} integer ratio 26, which is a ratio based on the 1^{st} channel frequency and the system clock 20, the sample rate converter 22 produces the 1^{st} data at a 2^{nd} frequency in the 1^{st} domain. For example, the 1^{st} domain may be the digital domain such that the 1^{st} sample rate converter 22 converts the rate of the digital 1^{st} data from the data rate of the first channel path to a second frequency, which is used throughout the analog front-end 10. The 1^{st} domain conversion module 24 receives the 1^{st} data at the 2^{nd} frequency in the 1^{st} domain and converts it into the 1^{st} data at the 2^{nd} frequency in the 2^{nd} domain. For example, the 1^{st} domain conversion module 24 converts the data from the digital domain to the analog domain.

The 2^{nd} channel path 14 includes a 2^{nd} sample rate converter 28 and a 2 domain conversion module 30. The 2^{nd} sample rate converter 28 is operably coupled to receive 2^{nd} data at a 2^{nd} channel frequency in the 1^{st} domain and to produce the 2^{nd} data at a 2^{nd} frequency in the 1^{st} domain based on the 2^{nd} integer ratio 32, which is a ratio between the system clock 20 and the 2^{nd} channel frequency. As such, the sample rate converter 28 converts the frequency of the 2^{nd} data from the 2^{nd} channel frequency rate to the 2^{nd} frequency. The 2^{nd} domain conversion module 30 receives the 2^{nd} data at the 2^{nd} frequency in the 1^{st} domain and converts it into the 2^{nd} data at a 2^{nd} frequency in the 2^{nd} domain.

As one of average skill in the art will appreciate, the 1^{st} domain conversion module 24 and the 2^{nd} domain conversion module 30 may receive their respective data at the 2^{nd} frequency in the 2^{nd} domain and convert it into the respective data at the 2^{nd} frequency into the 1^{st} domain. Similarly, the 1^{st} sample rate converter 22 and the 2^{nd} sample rate converter 28 may receive the 1^{st} and 2^{nd} data at the 2^{nd} frequency and convert it into the 1^{st} and 2^{nd} data at their respective channel frequencies. As one of average skill in the art will further appreciate, the 1^{st} data corresponds to a 1^{st} channel of a multi-channel telecommunication system and the 2^{nd} data corresponds to the 2^{nd} channel in the telecommunication system. As such, multiple communications may be supported via a single analog front-end as shown in FIG. 1. Conversely, multi-channels may be integrated into a single communication and supported by the analog front-end of FIG. 1.

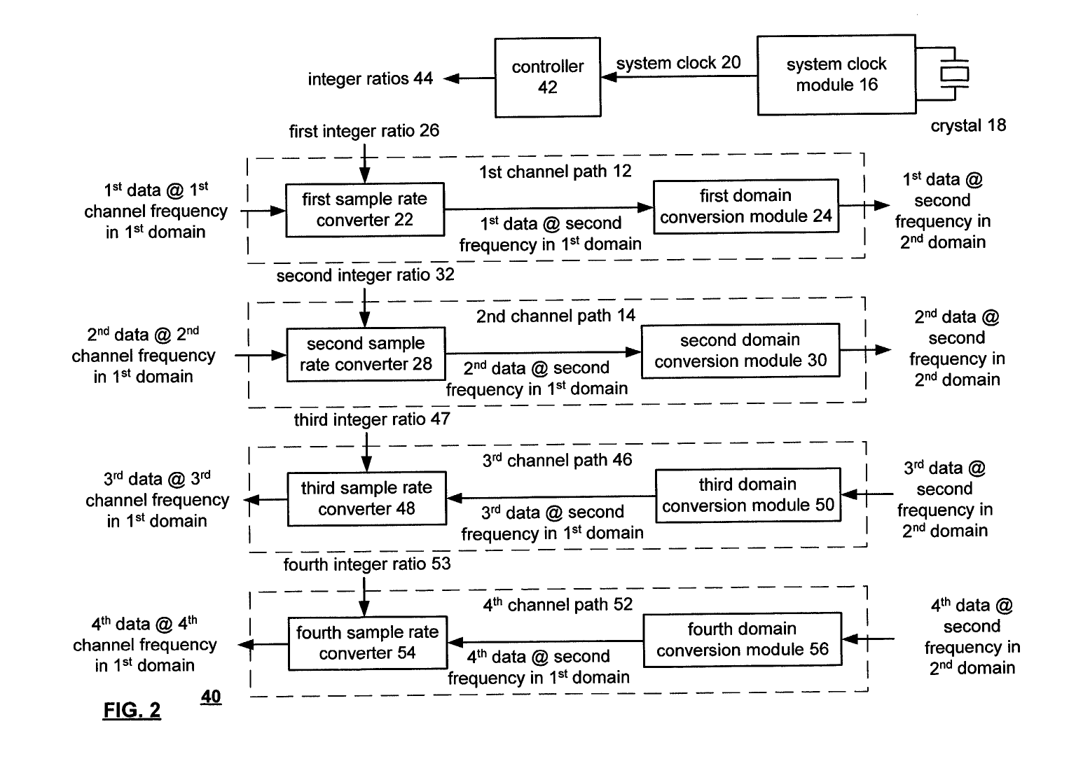

FIG. 2 illustrates a schematic block diagram of an alternate multi-channel analog front-end 40. The analog front-end 40 includes the system clock module 16, the 1^{st} channel path 12, the 2^{nd} channel path 14, a controller 42, a 3^{rd} channel path 46, and a 4^{th} channel path 52. The 1^{st} and 2^{nd} channel paths 12 and 14 include similar components and function in a similar manner as described with reference to FIG. 1. The controller 42 is operably coupled to receive the system clock 20 and produce integer ratios 44. The integer ratios 44 include the 1^{st} integer ratio 26, the 2^{nd} integer ratio 32, a 3^{rd} integer ratio 47, and a 4^{th} integer ratio 53. The controller, or control module, 42 determines the integer ratios based on the desired frequencies of the respective channel paths and the system clock. As such, the controller 42 may include circuitry to determine the frequency differences between the system clock and the frequencies of the channel paths to produce the integer ratios, it may include a lookup table based on the known data rates of the channel paths, or it may include a series of registers that are programmable by the user of the system.

The 3^{rd} channel path 46 includes a 3^{rd} sample rate converter 48 and a 3^{rd} domain conversion module 50. The 3^{rd} domain conversion module 50 receives 3^{rd} data at the 2^{nd} frequency in the 2^{nd} domain and converts it into the 3^{rd} data at the 2^{nd} frequency in the 1^{st} domain. The 3^{rd} sample rate converter 48 receives the 3^{rd} data at the 2^{nd} frequency in the 1^{st} domain and converts it into 3^{rd} data at the 3^{rd} channel frequency in the 1^{st} domain.

The 4^{th} channel path 52 includes a 4^{th} sample rate converter 54 and a 4^{th} domain conversion module 56. The 4^{th} domain conversion module 56 receives 4^{th} data at the 2^{nd} frequency in the 2^{nd} domain and converts it into the 4^{th} data at the 2^{nd} frequency in the 1^{st} domain. The 4^{th} sampling rate 54, based on the 4^{th} integer ratio 53, produces the 4^{th} data at the 4^{th} channel frequency in the 1^{st} domain.

As one of average skill in the art will appreciate, the 1^{st} and 2^{nd} domain conversion modules may be digital to analog converters while the 3^{rd} and 4^{th} domain conversion modules 50 and 56 may be analog to digital converters. As such, the 1^{st} and 3^{rd} paths may be used for transmit and receive paths of one telecommunication channel while the 2^{nd} and 4^{th} paths may be used for transmit and receive paths of a 2^{nd} telecommunication channel.

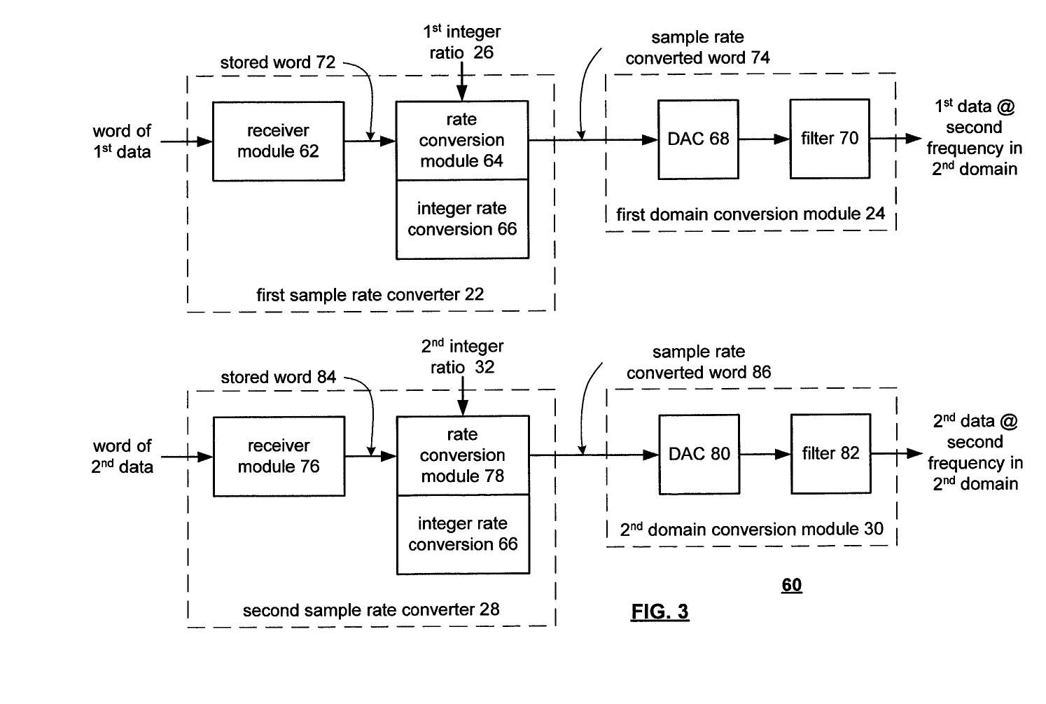

FIG. 3 illustrates a schematic block diagram of an analog front-end 60 that includes the 1^{st} sample rate converter 22, the 1^{st} domain conversion module 24, the 2^{nd} sample rate converter 28 and the 2^{nd} domain conversion module 30. The 1^{st} sample rate converter 22 is shown to include a receiver module 62, which is operably coupled to receive a word of the 1^{st} data. The word may be a single bit, multiple bits, 8 bits, 16 bits, et cetera of the 1^{st} data. The receiver module 62 stores the word of the 1^{st} data as a stored word 72. The rate conversion module 64, which may perform an integer rate conversion 66 based on the 1^{st} integer ratio 26, receives the stored word 72 and produces a sample rate converted word 74. The integer rate conversion 66 may be a function that repeats the word based on the 1^{st} integer ratio 26. For example, if the 1^{st} integer ratio is 3, the sample rate converted word 74 is 3 replications of the stored word 72. As such, the 1^{st} sampling rate converter 22, for this example, changes the rate of the 1^{st} data by a factor of 3.

The 1^{st} domain conversion module 24 includes a digital to analog converter 68 and a filter 70. The digital to analog converter 68 is operably coupled to receive the sample rate converted word 74 and convert it into an analog signal. The analog signal is filtered by filter 70 to produce the 1^{st} data at the 2^{nd} frequency in the 2^{nd} domain, which for this path is the analog domain.

The 2^{nd} sample rate converter 28 includes a receiver module 76, and a rate conversion module 78, which may perform the integer rate conversion 66. The receiver module 76 is operably coupled to receive a word of the 2^{nd} data and produce therefrom a stored word 84. The rate conversion module 78 based on the 2^{nd} integer ratio 32 produces a sample rate converted word 86 from the stored word 84.

The 2^{nd} domain conversion module 30 includes a digital to analog converter 80 and a filter 82. The digital to analog converter 80 receives the sample rate converted word 86 and produces an analog representation thereof. The analog signal is filtered via filter 82, which outputs the 2^{nd} data at the 2^{nd} frequency in the 2^{nd} domain. Note that the implementation of sample rate converter 22 and 28 could include any number of known sample rate conversion algorithms such as linear interpolation, table look up, etc.

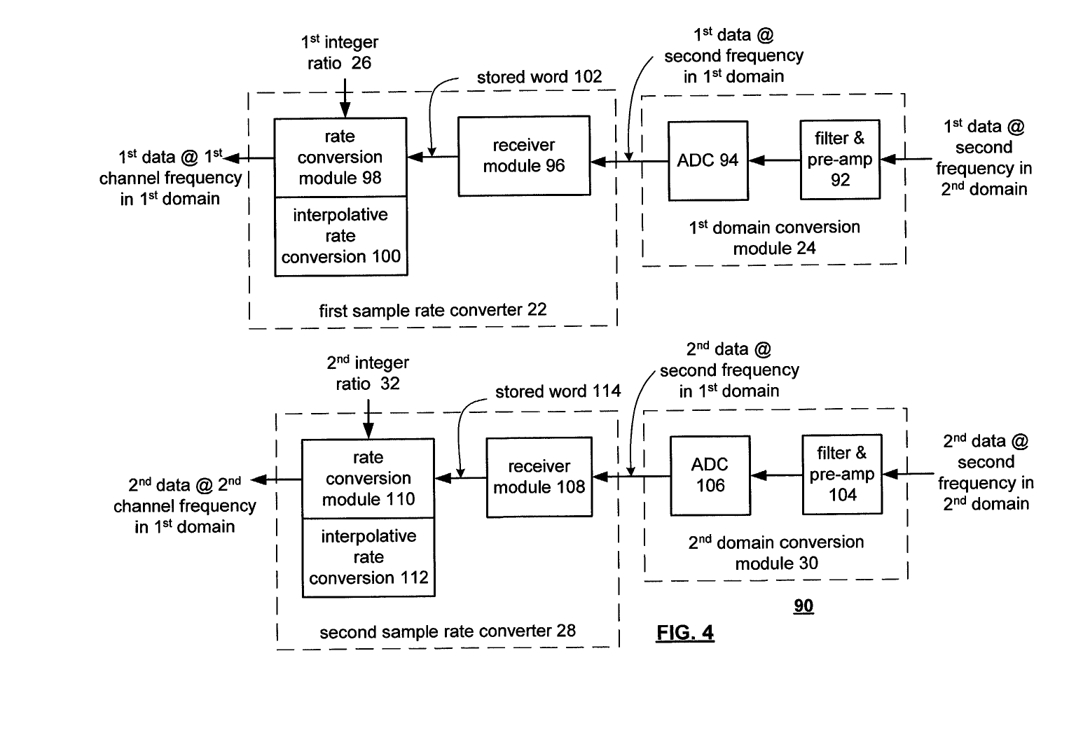

FIG. 4 illustrates a schematic block diagram of an analog front-end 90 that includes the 1^{st} sample rate converter 22, the 1^{st} domain conversion module 24, the 2^{nd} sample rate converter 28, and the 2^{nd} domain conversion module 30. The 1^{st} domain conversion module 24 includes an analog to digital converter 94 and a filter and pre-amp circuit 92. The filter and pre-amp circuit 92 is operably coupled to receive the 1^{st} data at the 2^{nd} frequency in the 2^{nd} domain (e.g. the analog domain), filter it, and amplify it. The filter and pre-amplifier 92 provides the filtered and amplified version of the 1^{st} data to the analog to digital converter 94. The analog to digital converter 94 converts the domain of the 1^{st} data into the digital domain thereby producing the 1^{st} data at the 2^{nd} frequency in the 1^{st} domain.

The 1^{st} sample rate converter 22 includes a receiver module 96 and a rate conversion module 98, which may do an interpolative rate conversion 100. The receiver module 96 receives a word of the 1^{st} data at the 2^{nd} frequency in the 1^{st} domain and stores it to produce a stored word 102. The rate conversion module 98 receives the stored word 102 and, based on the 1^{st} integer ratio 26, produces a word, partial word, or multiple words of the 1^{st} data at the 1^{st} channel frequency in the 1^{st} domain by utilizing an interpolative rate conversion process 100. The interpolative process utilizes linear or higher order functions of words to produce the resulting word of the 1^{st} data at the 1^{st} channel frequency in the 1^{st} domain. For example, if the integer ratio is 2.5, the 1^{st} two words would be replications of the stored word while the 3^{rd} word would be an interpolated word based on the words between the 1^{st} stored word and a 2^{nd} stored word. Alternatively, the rate conversion could be implemented as a decimation with the channel frequency less than or equal to the second frequency.

The 2^{nd} domain conversion module 30 includes an analog to digital converter 106 and a filter and pre-amp circuit 104. The filter and pre-amp circuit 104 is operably coupled to receive 2^{nd} data at the 2^{nd} frequency in the 2^{nd} domain (e.g. analog domain). The filter and pre-amp circuit process the 2^{nd} data and provides the processed data to the analog to digital converter 106. The analog to digital converter converts the 2^{nd} data into digital data, which is designated the 2^{nd} data at the 2^{nd} frequency in the 1^{st} domain.

The 2^{nd} sample rate converter 28 includes a receiver module 108 and a rate conversion module 110, which may perform an interpolative rate conversion 112. The receiver module 108 receives a word at a time of the 2^{nd} data at the 2^{nd} frequency in the 1^{st} domain to produce a stored word 114. The rate conversion module 110 receives the stored word 114 and, based on the 2^{nd} integer ratio 32, produces the 2^{nd} data at the 2^{nd} channel frequency in the 1^{st} domain. The rate conversion module 110 may utilize an interpolative rate conversion process 112, or a decimation rate conversion process (not shown), to perform the sample rate conversion.

As one of average skill in the art will appreciate, the rate conversion modules shown in FIGS. 3 and 4 may utilize an interpolative rate conversion, decimation sample rate conversion, an integer rate conversion, and/or any other known mechanism for sample rate conversion of data. As one of average skill in the art will also appreciate, by converting the channel frequencies all into the 2^{nd} frequency, all analog to digital conversion and digital to analog conversion is done on data having the same frequency. As such, noise, jitter, et cetera, which may be produced by having multiple clocks on a single substrate are substantially eliminated in the present analog front-ends.

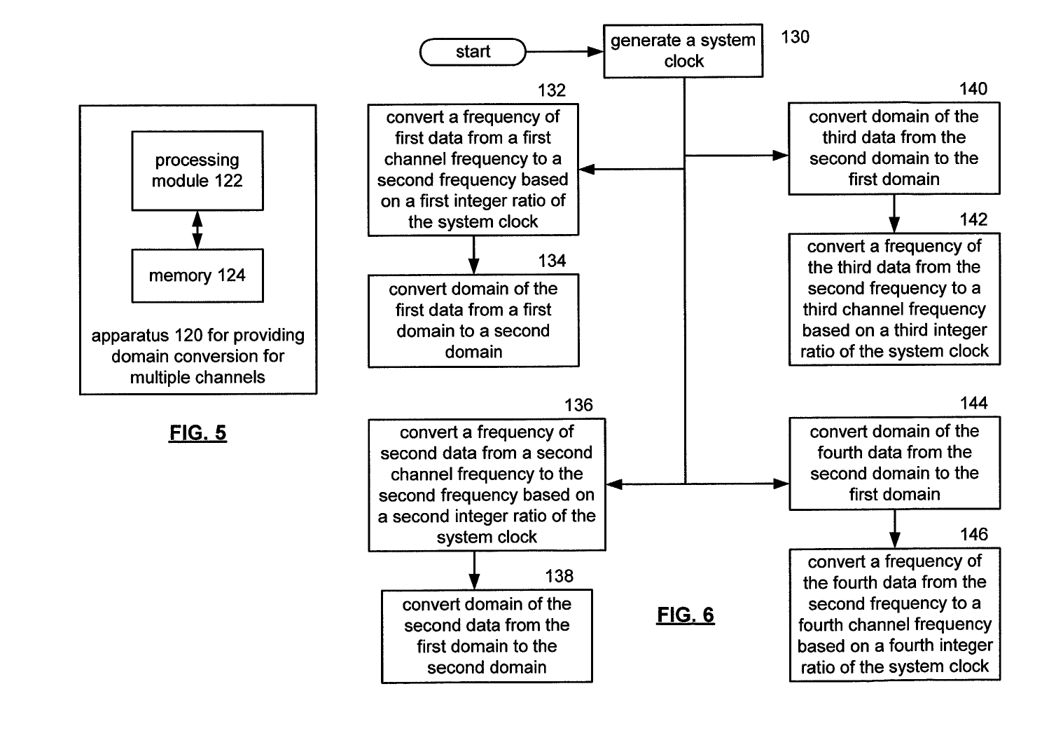

FIG. 5 illustrates a schematic block diagram of an apparatus 120 for providing domain conversions for multiple channels. The apparatus includes a processing module 122 and memory 124. The processing module 122 may be a single processing device or a plurality of processing devices. Such a processing device may be a microprocessor, microcontroller, digital signal processor, central processing unit, state machine, logic circuitry, and/or any device that manipulates signals (analog or digital) based on operational instructions. The memory 124 may be a single memory device or a plurality of memory devices. Such a memory device may be read-only memory, random access memory, floppy disk memory, system memory, hard drive memory, and/or any device that stores digital information. Note that when the processing module 122 implements one or more of its functions via a state machine or logic circuitry, the memory storing the corresponding operational instructions is embedded within the circuitry comprising the state machine or logic circuit. The operational instructions stored in memory 124 and processed by the processing module 122 are described in a logic diagram as shown in FIG. 6.

FIG. 6 illustrates a logic diagram of a method for providing domain conversions of multiple telecommunication channels on a single analog front end. The process begins at step 130, where a system clock is generated. The process then proceeds to steps 132, 136, 140, and 146. At step 134, a frequency of the 1^{st} data is converted from a 1^{st} channel frequency to a 2^{nd} frequency based on a 1^{st} integer ratio of the system clock. The 1^{st} integer ratio of the system clock is determined based on the 2^{nd} frequency, i.e. the frequency at which all channels are converted to, and the frequency of the 1^{st} data. The conversion may be done by storing a word of the 1^{st} data to produce a stored word. The stored word is then replicated based on the 1^{st} integer ratio to produce a sample rate converted word, which may be done by utilizing an integer replication or an interpolation replication.

The process then proceeds to Step 134 where the domain of the 1^{st} data is converted from a 1^{st} domain to a 2^{nd} domain. Note that the 1^{st} domain may be a digital domain and the 2^{nd} domain may be an analog domain. As such, the transmit data in a communication system may have its rate converted via a sample rate converter and then its domain converted by a digital to analog converter.

At Step 136, a frequency of 2^{nd} data is converted from a 2^{nd} channel frequency to the 2^{nd} frequency, i.e. the desired operating frequency of the integrated circuit, based on a 2^{nd} integer ratio of the system clock. The 2^{nd} integer ratio may be determined in a similar manner as the 1^{st} integer ratio. The process then proceeds to Step 138 where the domain of the 2^{nd} data is converted from the 1^{st} domain to the 2^{nd} domain.

At Step 140, the domain of the 3^{rd} data is converted from the 2^{nd} domain to the 1^{st} domain. The 2^{nd} domain may be an analog domain and the 1^{st} domain may be the digital domain. The process then proceeds to Step 140, where a frequency of 3^{rd} data is converted from the 2^{nd} frequency to a 3^{rd} channel frequency based on a 3^{rd} integer ratio of the system clock.

At Step 144, the domain of the 4^{th} data is converted from the 2^{nd} domain to the 1^{st} domain.. The process then proceeds to Step 146 where a frequency of the 4^{th} data is converted from the 2^{nd} frequency to a 4^{th} channel frequency based on a 4^{th} integer ratio of the system clock.

The preceding discussion has presented a method and apparatus for providing domain conversions for multiple channels in a single integrated analog front-end. As one of average skill in the art will appreciate, other embodiments may be derived from the teachings of the present invention without deviating from the scope of the claims. For example, more than two analog to digital converters and digital to analog converters may be utilized on a single integrated analog front-end, where each analog to digital converter and digital to analog converter pair constitute a transmit and receive telecommunication channel.

What is claimed is:

1. A multi-channel analog front end comprises:
system clock module operable to produce a system clock;
first channel path operable to process first data in a domain conversion, wherein the first channel path includes:
first sample rate converter operably coupled to convert a frequency of the first data from a first channel frequency to a second frequency based on a first integer ratio of the system clock and the first channel frequency; and
first domain conversion module converts domain of the first data from a first domain to a second domain;
second channel path operable to process second data in the domain conversion, wherein the second channel path includes:
second sample rate converter operably coupled to convert a frequency of the second data from a second channel frequency to the second frequency based on a second integer ratio of the system clock and the second channel frequency; and
second domain conversion module converts domain of the second data from the first domain to the second domain.

2. The multi-channel analog front end of claim 1 further comprises:
third channel path operable to process third data in an inverse domain conversion, wherein the third channel path includes:
third sample rate converter operably coupled to convert a frequency of the third data from the second frequency to a third channel frequency based on a third integer ratio of the system clock and the third channel frequency; and
third domain conversion module converts domain of the third data from the second domain to the first domain;
fourth channel path operable to process fourth data in the inverse domain conversion, wherein the fourth channel path includes:
fourth sample rate converter operably coupled to convert a frequency of the fourth data from the second frequency to a fourth channel frequency based on a fourth integer ratio of the system clock and the fourth channel frequency; and
fourth domain conversion module converts domain of the fourth data from the second domain to the first domain.

3. The multi-channel analog front end of claim 1 further comprises:
a control module operably coupled to determine the first and second integer ratios of the system clock based on the second frequency and the frequencies of the first and second data, respectively.

4. The multi-channel analog front end of claim 3, wherein the first sample rate converter further comprises:
receiver module operably coupled to receive a word of the first data and to store the word to produce a stored word; and
rate conversion module operably coupled to retrieve the stored word and to replicate the stored word based on the first integer ratio of the system clock to produce a sample rate converted word.

5. The multi-channel analog front end of claim 4, wherein the rate conversion module further comprises:
integer rate conversion module operably coupled to produce integer replications of the stored word to produce the sample rate converted word.

6. The multi-channel analog front end of claim 4, wherein the rate conversion module further comprises:
interpolative rate conversion module operably coupled to produce at least one replication of the stored word and an interpolated representation of the stored word to produce the sample rate converted word.

7. The multi-channel analog front end of claim 3, wherein the second sample rate converter further comprises:
receiver module operably coupled to receive a word of the second data and to store the word to produce a stored word; and
rate conversion module operably coupled to retrieve the stored word and to replicate the stored word based on the second integer ratio of the system clock to produce a sample rate converted word.

8. The multi-channel analog front end of claim 7, wherein the rate conversion module further comprises:
integer rate conversion module operably coupled to produce integer replications of the stored word to produce the sample rate converted word.

9. The multi-channel analog front end of claim 7, wherein the rate conversion module further comprises:
interpolative rate conversion module operably coupled to produce at least one replication of the stored word and an interpolated representation of the stored word to produce the sample rate converted word.

10. The multi-channel analog front end of claim 1, wherein the each of the first and second domain conversion modules further comprises at least one of: an analog to digital converter and a digital to analog converter.

11. The multi-channel analog front end of claim 1, wherein the each of the first and second domain conversion modules further comprises a filtering module operably coupled to filter the first and second data respectively.

12. A method for providing domain conversion for multiple channels, the method comprises the steps of:
generating a system clock;
converting a frequency of first data from a first channel frequency to a second frequency based on a first integer ratio of the system clock and the first channel frequency;
converting domain of the first data from a first domain to a second domain;
converting a frequency of second data from a second channel frequency to the second frequency based on a second integer ratio of the system clock and the second channel frequency; and
converting domain of the second data from the first domain to the second domain.

13. The method of claim 12 further comprises:
converting a frequency of the third data from a third channel frequency to the second frequency based on a third integer ratio of the system clock and the third channel frequency;
converting domain of the third data from the second domain to the first domain;
converting a frequency of the fourth data from a fourth channel frequency to the second frequency based on a fourth integer ratio of the system clock and the fourth channel frequency; and
converting domain of the fourth data from the second domain to the first domain.

14. The method of claim 12 further comprises:
determining the first and second integer ratios of the system clock based on the second frequency and the frequencies of the first and second data, respectively.

15. The method of claim 14, wherein the converting the domain of the first and second data from the first domain to the second domain further comprises:
storing a word of the first and second data to produce a stored word; and
replicating the stored word based on the first and second integer ratios to produce a sample rate converted word, respectively, based on at least one of: an integer replication and an interpolation replication.

16. An apparatus for providing domain conversion for multiple channels, the apparatus comprises:
processing module; and
memory operably coupled to the processing module, wherein the memory includes operational instructions that cause the processing module to:
generate a system clock;
convert a frequency of first data from a first channel frequency to a second frequency based on a first integer ratio of the system clock and the first channel frequency;
convert domain of the first data from a first domain to a second domain;
convert a frequency of second data from a second channel frequency to the second frequency based on a second integer ratio of the system clock and the second channel frequency; and
convert domain of the second data from the first domain to the second domain.

17. The apparatus of claim 16, wherein the memory further comprises operational instructions that cause the processing module to:
convert a frequency of the third data from a third channel frequency to the second frequency based on a third integer ratio of the system clock and the third channel frequency;
convert domain of the third data from the second domain to the first domain;
convert a frequency of the fourth data from a fourth channel frequency to the second frequency based on a fourth integer ratio of the system clock and the fourth channel frequency; and
convert domain of the fourth data from the second domain to the first domain.

18. The apparatus of claim 16, wherein the memory further comprises operational instructions that cause the processing module to:
determine the first and second integer ratios of the system clock based on the second frequency and the frequencies of the first and second data, respectively.

19. The apparatus of claim 18, wherein the memory further comprises operational instructions that cause the processing module to convert the frequency of the first and second data from the first and second channel frequencies to the second frequency, respectively, by:
storing a word of the first and second data to produce a stored word; and
replicating the stored word based on the first and second integer ratios to produce a sample rate converted word, respectively, based on at least one of: an integer replication and an interpolation replication.
